(19) United States
(12) Patent Application Publication
(10) Pub. No.: US 2006/0274401 A1
(43) Pub. Date: Dec. 7, 2006

(54) Single-photon generator

(76) Inventor: Shuichiro Inoue, Tokyo (JP)

Correspondence Address: PATENTTM.US, P. O. BOX 82788, PORTLAND, OR, 97282-0788, US

(21) Appl. No.: 10/554,006

(22) PCT Filed: Apr. 22, 2004
(86) PCT No.: PCT/JP04/05803

§ 371 Date: Aug. 2, 2006

(30) Foreign Application Priority Data
Apr. 22, 2003 (JP) 2003117055

(51) Int. Cl. G02F 1/35

(52) U.S. Cl. 359/326

(57) ABSTRACT

A single-photon generator for generating a single photon with high efficiency at a constant frequency. A CW semiconductor laser (1) emits a laser beam of wavelength 780 nm. A photon of wavelength 780 nm is divided into two photons of wavelengths 1550 and 1570 nm by means of a non-degenerate waveguide PPLN (2). A dichroic mirror (6) separates the two photons. A gate-operation single-photon detector (4) detects one of the photons and generates a detection signal. An LN polarization modulator is operated with the detection signal. An optical switch (5) composed of the LN polarization modulator and a polarized beam splitter rotates the polarization of the other photon by 90° and outputs the photon in a given direction. With this, only one photon can be taken out in the direction of the travel at a frequency of several hundreds of kilohertz. Two photons of different wavelengths are produced by spontaneous parametric down-conversion by a non-degenerate waveguide PPLN, the photons are separated by a dichroic mirror, one of the photons is detected by a gate-operation single-photon detector, and the output of the other photon is controlled by a high-speed LN polarization modulator. Therefore, a single photon can be efficiently produced at a constant frequency.

### TECHNICAL FIELD

The present invention relates to a single-photon generator especially to a single-photon generator that separates a single photon out of two photons generated by collision of a laser light against a non-linear optical crystal and converted with a spontaneous parametric down-conversion.

### BACKGROUND ART

Recently, a public-key cryptography is widely used for distributing the key for the cryptography system. In the future, a cryptography technique will be demanded that is in principle unable to be eavesdropped and decoded. Quantum cryptography is the cryptography that is in principle unable to be eavesdropped and decoded and completely solves the problem of the cryptography key distribution. Moreover, “Interaction-free measurements” enable “View without light”. If the Interaction-free measurements are achieved in parallel, then “Interaction-free imaging” that views objects without lighting is put into reality. Since the quantum cryptography and the Interaction-free measurements utilize the nature of quantum mechanics, techniques that generate a single photon are required.

Formerly, a light pulse that is attenuated to the single photon level is used as a photon source. This light source has a probability that not less than 2 photons exist in a pulse since the photon statistics follows the Poisson distribution, which remains possibility of being eavesdropped by a beam-splitter attack and the like, since the quantum-cryptography communication system assures security by transmitting a single photon. The former quantum-cryptography techniques have generated the single photon by attenuating the pulse from the laser until the mean photon number in the pulse was reduced to 0.1. With this means, the single photon exists at 10% of all the pulses, and the rate of key distribution is low. Increasing the mean photon number may improve this low rate, which also increases the probability that not less than 2 photons exist in a pulse since the photon number in a pulse follows the Poisson statistics. As a result, the security of the quantum cryptography fails. As an example of the single-photon generator in the former arts, there exists a technique using a quantum dot. This technique requires operations under extreme-low temperature and generating a photon at around 1550-nm band is difficult, application to the quantum cryptography communication system is difficult. Therefore, generation of the single photon with SPDC (Spontaneous Parametric Down Conversion) as a nonlinear optical process is widely used. The SPDC converts a photon with high energy down to two photons with low energy. In the following, a single-photon generator using a pair of photons generated with the SPDC is explained.

The SPDC converts the wavelength using second-order non-linearity of a nonlinear optical crystal. A photon with wavelength λ₀ is converted to photons with wavelengths λ₁ and λ₂ satisfying the conditions of energy-conservation law and momentum-conservation law (phase-matching condition) in equations
hc/λ₀=hc/λ₁+hc/λ₂,
kₚ=kₛ+kₜ,
where h is the Plank constant, c is the velocity of the light. If equation λ₁=λ₂=2 λ₀ stands, the conversion is called degenerate parametric down-conversion. If equation λ₁≠λ₂≠2 λ₀ stands, the conversion is called non-degenerate parametric down-conversion. There are two means for the phase matching. One is an angle-phase matching in bulk crystals of BBO (Beta Barium Borate) or LN (Lithium Niobate), which satisfies the phase-matching condition if the input direction of the pump light against the optical axis of the crystal is properly adjusted. Photons that form the photon pair are called an idler photon and a signal photon. If the polarizations of the signal photon and the idler photon are the same, and this polarization has the right angle with the polarization of the pump light, this type is called a type-I phase matching. On the other hand, the type with the polarization of the signal photon having the right angle against that of the idler photon is called type-II phase matching. Another means for the phase matching is QPM (Quasi Phase Matching). This achieves quasi-phase matching by forming a periodically poled structure on the crystal. Then, a signal photon and an idler photon with the same polarization with the pump light are generated, which is called type-0 phase matching. In order to output the photon of wavelength 1550 nm, PPLN (Periodically Poled Lithium Niobate) is available.

The pair of photons generated with the spontaneous parametric down-conversion, namely a signal photon and an idler photon, has a complete correlation in the time domain. As shown in FIG. 14, if the photon detector D₁ detects an idler photon, the detection signal has information of the timing that a signal photon exists at. Therefore, opening the gate of the optical switch only when a photon is detected with the detector D₁ enables precise output of the correlated photon. This means is called post selection. In the following, presented are some conventional examples for generating a single photon. “Single photon generating device” disclosed in Patent Reference 1 generates only one photon in a pulse. As depicted in FIG. 15(a), a pair of photons correlated on the generation time consisting of a signal photon and an idler photon is generated with a photon-pair source. The photon-pair source generates a fluorescent-light pair with vertical and horizontal polarization directions by pumping a QPM-type nonlinear optical medium with laser lights. A photon detector detects the input of the idler photon. In the gate-device controlling portion, a signal to open/close the gate is generated only at less than a predetermined number of times during a constant period determined by the clock signal out of a clock generator. The gate device is opened and closed following the timing signal from the gate-controlling portion.

“Key distribution system using quantum cryptograph” disclosed in Patent Reference 2 is a quantum-cryptograph system distributing a key using a single photon that is generated by the single-photon generator as shown in FIG. 15(b). A laser pumps the nonlinear crystal such as KDP. The parametric down-conversion with a crystal generates two photon-beams. A photon in one beam is detected by a photon detector, and triggers the gate that opens a shutter to let the single photon pass through.”

“Single Photon Source with Individualized Single Photon Certifications” disclosed in Non-patent Reference 2, as shown in FIG. 16(a), aligns in rows down-converters with nonlinear crystals. Each down-converter is capable of generating a pair of photons. Each down-converter has a photon detector. If the photon detector detects a photon, it triggers an optical switch and outputs the photon.

“Stored-type single photon generating device” disclosed in Non-patent Reference 3, as shown in FIG. 16(b), is a photon source that generates a single photon on pseudo-demand from stored down-conversion. The parametric down-conversion generates the pair of photons. The photons are stored in a storage loop with an optical switching gate controlled by the detection signal from the photon detector. The photon can be taken out on demand by opening the switching gate.

Patent Reference 1: Japan Patent Publication No. Tokkai 2000-292821

Patent Reference 2: Japan Patent Publication No. Tokuhyou Hei 8-505019

Non-patent Reference 1: Z. Walton, A. V. Sergienko, M. Atature, B. E. A. Saleh, and M. C. Teichl, “Performance of Photon-Pair Quantum Key Distribution System”, J. Mod. Opt. Vol. 48, No. 14, pp. 2055-2063, (Apr. 22, 2001).

Non-patent Reference 2: A. L. Migdall, D. Branning, S. Castelletto and M. Ware, “Single Photon Source with Individualized Single Photon Certifications”, Proc. of the SPIE Vol. 4821, pp. 455-465, (2002).

Non-patent Reference 3: T. B. Pittman, B. C. Jacobs, and J. D. Franson, “Single Photons on Pseudo-Demand from Stored Parametric Down-Conversion”, Phys. Rev. A66, 042303 (2002).

### DISCLOSURE OF THE INVENTION

However, the single-photon generator by the conventional arts has a drawback that it could not efficiently generate the single photon at a constant period. The present invention aims at efficiently generating the single photon at a constant period. In order to solve the problem above mentioned, the present invention has a structure of the single-photon generator comprising a CW-laser-light source, a wave-guide-type quasi-phase-matching LiNbO₃ that converts one photon from the laser-light source into two photons with a wavelength, a beam splitter that separates the two photons, a single-photon detector of gate operation to detect one of the split photon, and an optical switch that takes the other split photon in and is controlled by the detection signal from the single-photon detector.

This structure of the present single-photon generator enables efficient generation of the single photon by the procedure that two photons generated by the spontaneous parametric down-conversion (nonlinear optical process of the laser light and the crystal) are efficiently separated using the optical switch at high probability into a single photon with a constant polarization direction. The present invention may be applied to a quantum cryptography and enables secure key distribution at high bit rate even over a long-distance communication system.

### BRIEF EXPLANATION OF THE FIGURES

FIG. 1 depicts a schematic diagram of the single-photon generator in an embodiment of the present invention.

FIG. 2 depicts the dependency of P(n′) upon Tₛ/T_{d}.

FIG. 3 depicts the probability of the photon number at TₛT_{d}=0.2

FIG. 4 depicts a schematic diagram of the photon-pair generator.

FIG. 5 shows the relationship between the output power measured by a power meter and the pump wavelength.

FIG. 6 depicts the experimental results at RT_{d}=1.44,

FIG. 7 depicts the comparison of the experimental results against the calculation.

FIG. 8 depicts a means to prolong the open-gate time of the photon detector for the post-selection side.

FIG. 9 depicts a circuit that generates the control signal by detecting an avalanche signal,

FIG. 10 depicts a waveform of the control signal.

FIG. 11 depicts a schematic diagram of the single-photon generator that uses a wave-guide-type PPLN,

FIG. 12 depicts a comparison of the cases on the control-signal input of 1 ns against that of 5 ns.

FIG. 13 depicts detection probabilities of the photon detector D₂ at control-signal occurrences of 6, 30, 37, and 41 kHz.

FIG. 14 depicts a schematic diagram of a single-photon generator with spontaneous parametric down-conversion by the former arts.

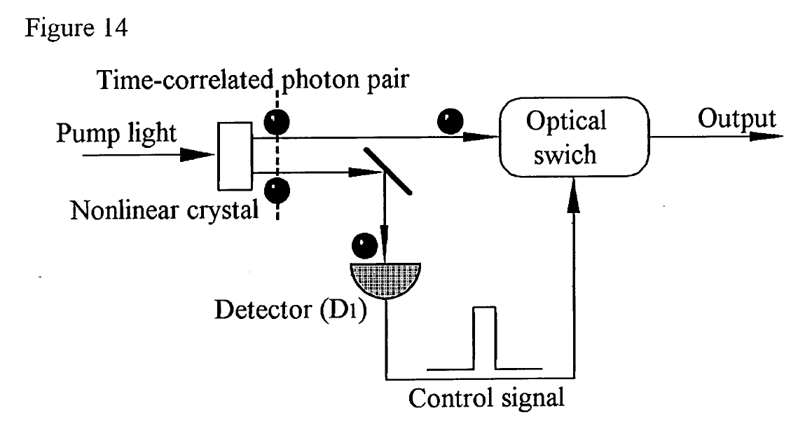

FIG. 15 depicts a schematic diagram of a single-photon generator by the former arts.

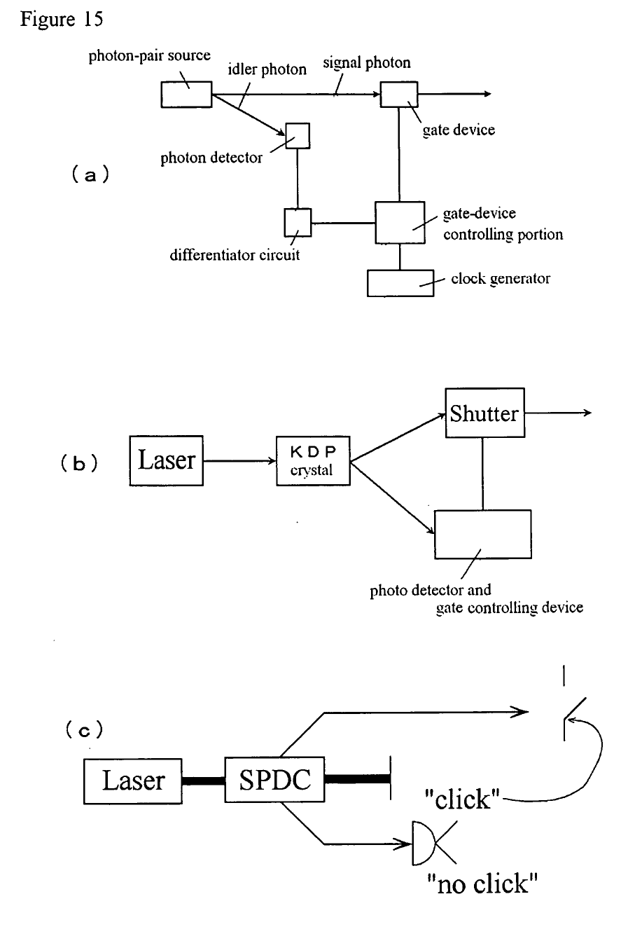

FIG. 16 depicts a schematic diagram of another single-photon generator by the former arts.

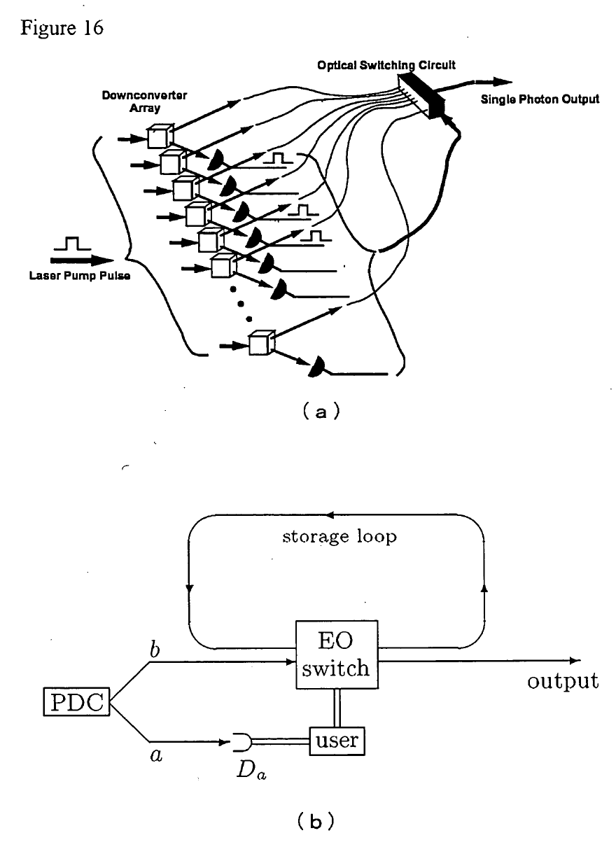

### THE BEST EMBODIMENT OF THE PRESENT INVENTION

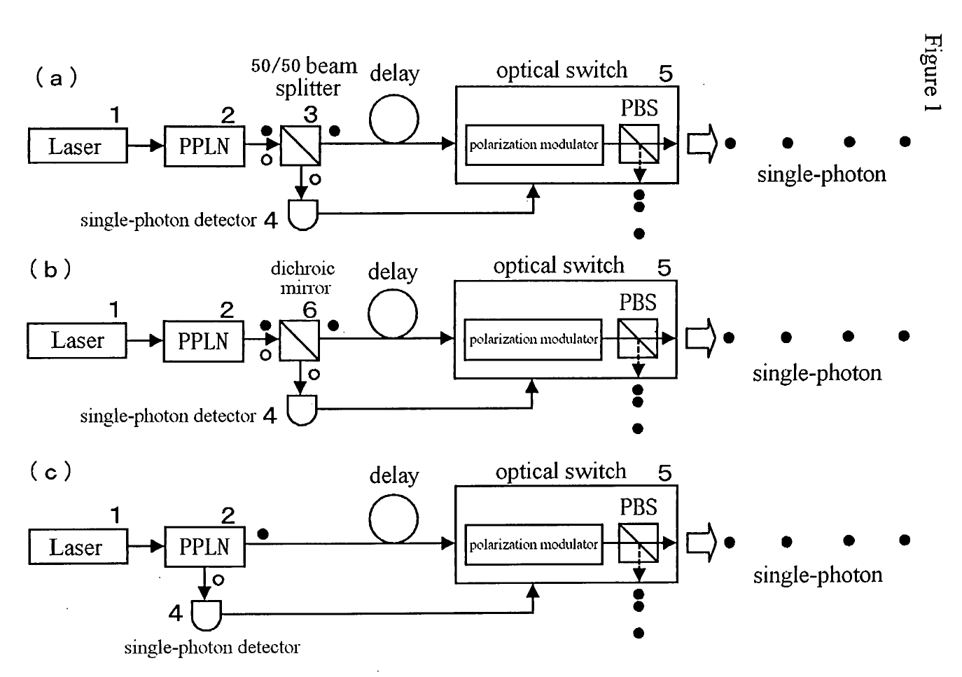

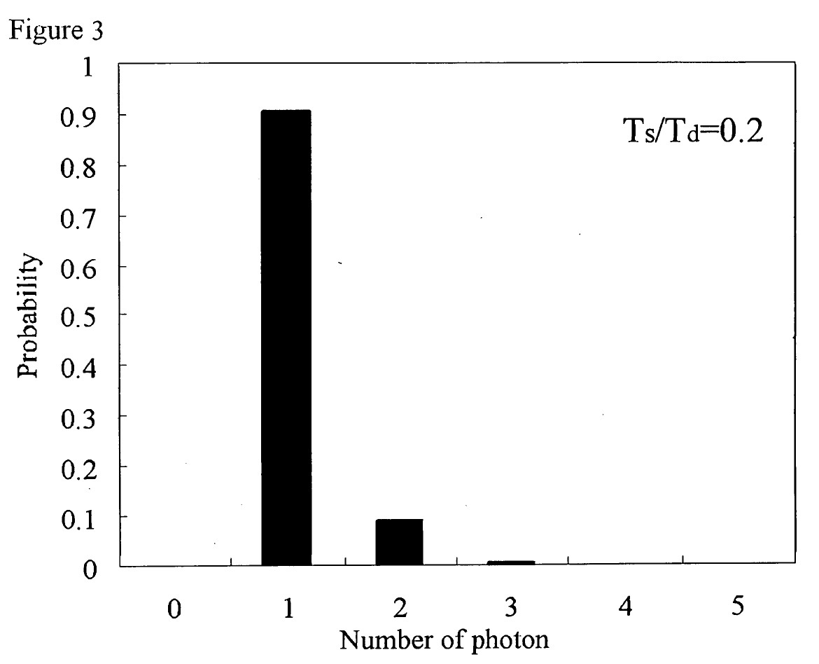

In the following, the best embodiment of the present invention is precisely explained with reference to FIGS. 1 through 13

The embodiment of the present invention is a single-photon generator that generates two photons with spontaneous parametric down-conversion, and lets a single photon of them selectively pass through an optical switching gate using an LN polarization modulator.

FIG. 1 shows the schematic diagram of the single-photon generator in the embodiment of the present invention. In FIG. 1, laser 1 is a CW semiconductor laser with wavelength 775 nm. PPLN 2 is a wave-guide-type PPLN (Bulk-type quasi-phase matching LiNbO₃) that converts one photon at wavelength 775 nm into two photons at wavelength 1550 mm. Beam splitter 3 is a means that splits the two photons. Gate-operation single-photon detector 4 is a sensor that can detect a single photon during a certain time period. Optical switch 5 is an optical switch consisting of the LN-polarization modulator and the polarization beam splitter. Optical switches configured otherwise than this may be used. Dichroic mirror 6 is a mirror that separates photons of different wavelengths. APD is an avalanche photo diode. D₁ and D₂ are photon detectors. DM₁ and DM₂ are dichroic mirrors. L₁, L₂, and L₃ are lenses. SMF is a single-mode fiber.

Here is explained an operation of the single-photon generator in the embodiment of the present invention as configured above. As shown in FIG. 1(a), the single-photon generator consists of the CW semiconductor laser 1 with wavelength 775 nm, the PPLN 2, and the optical switch 5, wherein the optical switch 5 consists of the LN-polarization modulator and the polarization-light-beam splitter. The CW semiconductor laser 1 with wavelength 775 nm pumps the wave-guide-type quasi-phase matching LiNbO₃ (nonlinear crystal), and a non-linear optical process called the spontaneous parametric down-conversion continuously generates pairs of correlated photons of wavelength 1550 nm.

Here is explained the generation of the photon pairs by the waveguide-type PPLN. In order to raise the probability for generating the single photon from the photon pairs with the spontaneous parametric down-conversion, raising the probability (R) of the photon-pair generation is important. For this purpose, the waveguide-type PPLN (denoted PPLN-WG in the following) is adopted as a down-conversion device. The PPLN-WG has a better probability of photon generation than bulk crystals, whose reasons are presented in the following. For the first, the waveguide structure enables long interaction length keeping a pumping power density high. For the next, the quasi-phase matching enables using the largest non-linear optical constant d₃₃ in inorganic materials. Furthermore, PPLN-WG is capable of generating photon pairs of wavelength 1550 nm by pumping at wavelength 775 nm.

In the waveguide-type PPLN2 (Converting a photon of wavelength 775 nm into two photons of wavelength 1550 nm), the CW semiconductor laser 1 of wavelength 775 nm having an output power of several mW pumps the waveguide-type PPLN2 in order to raise the conversion efficiency, when the temperature of the waveguide-type PPLN2 is kept around 125 degrees Centigrade to 150 degrees Centigrade with an oven in order to prevent the degradation of the conversion-efficiency by photo-refractive effects. The single-photon detector 4 operating at a gate period around 20 ns that is the dead time for the single-photon detector detects one of the generated pair of photons of wavelength 1550 nm. Polarization of the other photon of the pair is rotated by 90° and only a single photon is taken out toward the traveling direction at period of several 100 kHz. In order to operate the LN polarization modulator within around the 200-ps jitter period of the detection signal, the modulator must be capable of operating at around 5 GHz.

Accordingly, only when one of the pair photons generated with the parametric down-conversion is detected (post-selected), the optical switch 5 lets the other photon pass through, and by this process a single-photon source comes in practice. The time resolution of the optical detector 4 for the post selection at 1550-nm wavelength is around 100 ps and restricts the frequency response of the optical switch 5 at no more than 2 GHz. Under this restriction, the best rate of generating the photon pair is 2.5×10⁸ particles/s. Further raising the generation rate than this rate just results in raising probability of switching on more than 2 photons simultaneously. In order to operate at the best generation rate, the waveguide-type down-conversion PPLN 2 is used as the down-conversion device, and is pumped by the CW laser at wavelength 775 nm, and the photon pair of wavelength 1550 nm is generated. When the output power of the light pump is around 1 mW, the best rate of generating photon pairs is achieved.

Since the photon pairs generated by the PPLN 2 all have one direction, they are forced to separate by the beam splitter 3. The photon detector 4 at wavelength 1550 nm works with gate operation, the period of which is usually as short as 1 ns to suppress dark counts. However, in order to raise the probability for the post selection, this gating period is prolonged to 20 ns, when five photons in average come in. A passive quenching effect in the sensing circuit of the detector 4 after receiving a detection signal by the first-photon input through the open gate prevents detecting further input photons. This detection signal is used as the control signal for the optical switch 5. Since the photon pair going out of the PPLN 2 has a constant polarization direction, an optical polarization switch with a polarization light-beam splitter is applied for the optical switch 5. A polarization controller with a bandwidth 10 GHz controls the polarization. One photon only comes in through the gate with probability of 40% during the open-gate period under the condition that the quantum efficiency is 25% and the single-photon detector 4 with dark counts of 6×10⁻⁴ per 20 ns is used. The probability that more than 2 photons come in is suppressed down to 1%. This performance is as good as that of the case the light pulse is attenuated until the mean photon number decreases down to 0.1.

A single-photon generator presented in FIG. 1(b) uses a non-degenerate wave-guide-type PPLN that can convert a photon of wavelength 775 ns into two photons of wavelengths 1530 ns and 1570 ns. Detecting photons with a gate at different wavelengths may raise efficiency in using photons. This enables even better probability to generate a single photon than the degenerate-waveguide-type PPLN, where instead of the 50/50 beam splitter 3, dichroic mirror 6 is used.

A single-photon generator presented in FIG. 1(c) converts a photon of wavelength 775 nm into 2 photons. A bulk PPLN is used that can generate these photons at different directions in the plane of the pump-light direction, which enables splitting a photon pair in space and may raise efficiency in using photons, and further dispenses with the 50/50 beam splitter.

The photon statistics of the light pulse simply attenuated in the former arts follows the Poisson distribution. However, in this embodiment of the present invention, only when one of the photon pair is post-selected, the other photon is taken out, which may suppress the fluctuation of photons at less than the Poisson statistics. Furthermore, the optical switch utilizes the polarization states, and can separate a single photon at high probability. As a result, the emitted photon has a constant polarization direction and is a very easy-to-handle light source. The single-photon light source with the optical switch suppresses the probability that more than 2 photons are emitted simultaneously and may emit the single photon at high probability.

In the following, explained are experimental results in operating the single-photon generator by the present invention. Firstly, generation of the pair of photons is explained. Probability P(n) that the number of existing idler photons is n during the measurement time T_{d} of the photon detector D₁ is denoted in the following equation,
P(n)={exp(−RT_{d})}(RT_{d})ⁿ/(n!).

Where, R is the generation probability of the photon pair. The optical switch opens the gate only if an idler photon is detected. Therefore, if the switch gate is opened, a signal photon is necessarily put out. Probability that the number of signal photons is n′ during the period Ts when the switch gate is open is given in the following equations,
P(0)=0
P(n′)=F(n′)/{Σₘ₌₁^{∞}F(m)}
F(m)={exp(−RTs)}(RTs)^{m}/(m!).
Where, let RT_{d}=1, i.e. one pair of photons is generated during T_{d} in average, and RTs=Ts/T_{d} stands up.

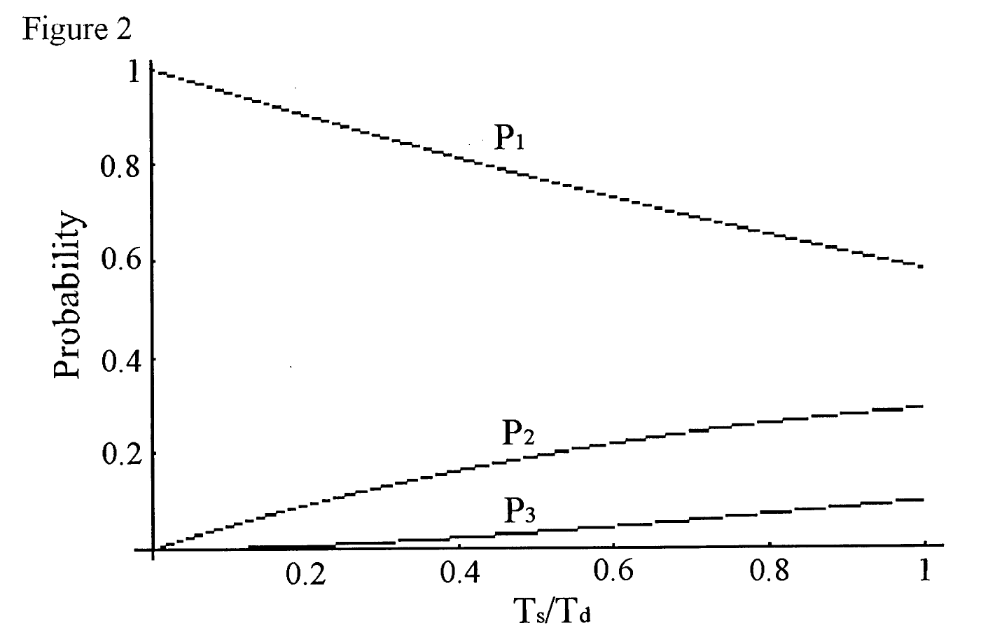

FIG. 2 shows the dependency of P(n′) on Ts/T_{d}. Obviously by FIG. 2, decreasing Ts/T_{d} may suppress the probability of generating a number of signal photons. This means to suppress generating a number of photons necessarily requires the photon-detection signal at the post-selection for controlling and detecting the photon from the light source that continuously generates photon pairs. Furthermore in the practical cases, P(0) exists or P(0)≠0, out of the optical loss in the system and dark counts of the photon detector.

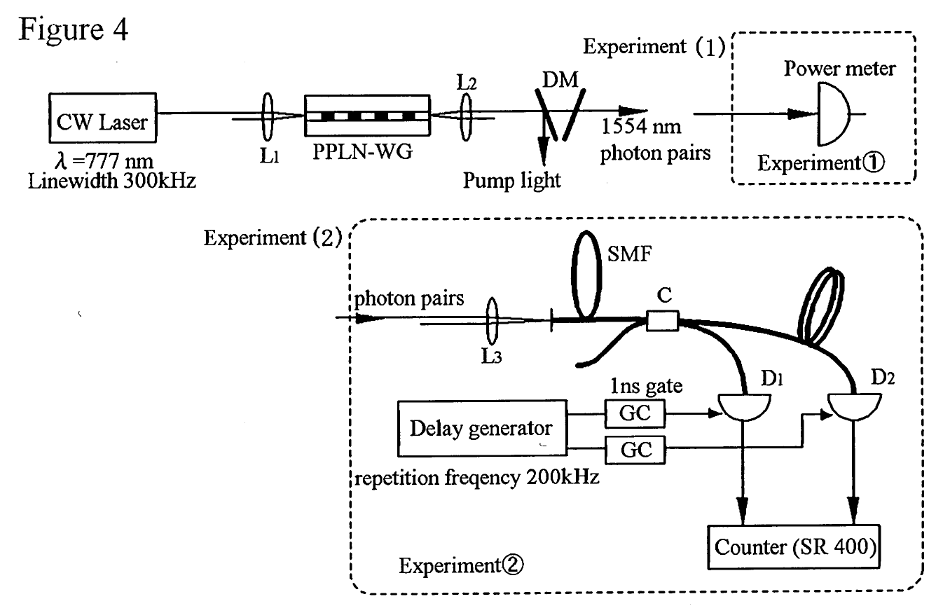

FIG. 4 shows a schematic diagram of the photon-pair generator. As shown in FIG. 4, the CW laser (NEW FOCUS Tunable Diode Laser) that has 777-nm wavelength, 5-mW mean power, and 30 kHz of line width puts out the pump light, and the lens L₁ guides the light into the PPLN-WG with a crystal of 30-mm length. The temperature of the PPLN-WG is set as high as 70° C. in order to prevent the light damage. Degenerate parametric down-conversion continuously generates a pair of photons consisting of a signal photon and an idler photon of wavelength 1554 nm. The lens L₂ collimates the generated output and the dichroic mirrors DM₁ and DM₂ stop the pump light. The experiment (1) guides the output photon that passed through the dichroic mirrors DM₁ and DM₂ into a power meter. The experiment (2) guides the output photon into an SMF (single-mode fiber) through the lens L₃. Then, a 50/50 single-mode coupler separates the signal photon and the idler photon, and photon detectors D₁ and D₂ detect the photons. As the photon detector, is used a gate operation of InGaAs/InP-APD (EPITAXX EPM239-BA) cooled with a Peltier device down to −48° C. The counter (STANFORD RESEARCH SYSTEM SR400) simultaneously counts the detection signals from the photon detectors D₁ and D₂, when the delay generator (STANFORD RESEARCH SYSTEM SDG535) retards the gate-voltage pulse of around 1-ns width to the photon detectors D₁ and D₂.

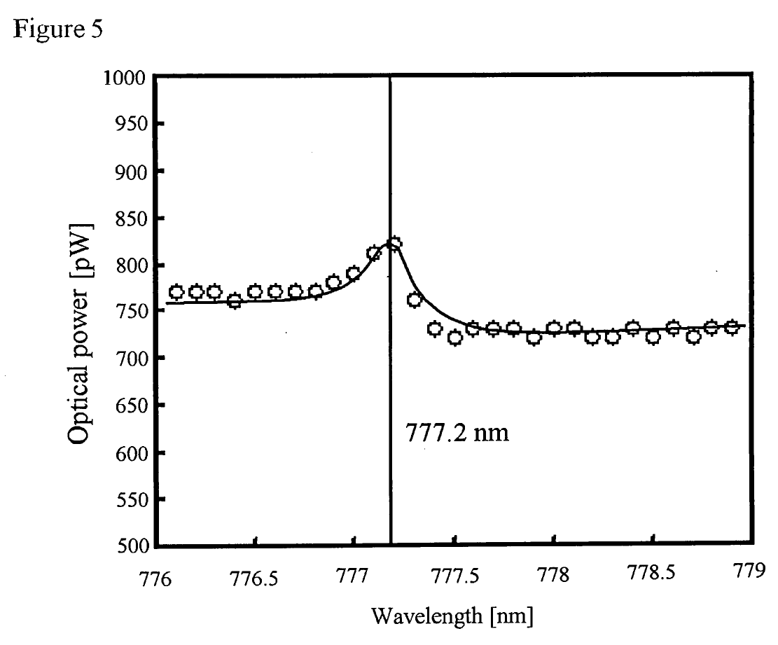

Experiment (1) measured the output power at 1550-nm band under different wavelengths of the pump light, where the pump power injected into the waveguide was 1.5 mW. FIG. 5 shows the relationship between the output power measured by the power meter and the wavelength of the pump light. In the figure, a peak is found at wavelength 777.2 ms, which means that the phase-matching wavelength of the employed PPLN-WG at 70° C. is 777.2 ms. The offset comes from the background of the experiment setup and the drift current in the power meter. The height of the peak proves that the output power of 500 pW is available at 1554-nm wavelength. In the experiment (2), the wavelength of the pump at 777.2 nm and the photon pairs with 1554-nm wavelength generated by the PPLN-WG were detected using the single-photon detector. The count rate with the photon detectors D₁ and D₂ whose gates are operating at 200 kHz was 1.6×10⁴ at a single count.

Here is explained the mean occurrence of the photon pairs estimated by the power meter and the count in the single photon detector. The energy that a single photon with 1554-nm wavelength has is given in equation,
wₚₕ=hν=hc/λ=6.63×10^{-34×3×10}⁸/(1554×10⁻⁹)=1.29×10⁻¹⁹.

Here, R denotes the occurrence of the photon-pair generation, T_{d} denotes the gate width, and Wg that denotes the photon power coming in during the open-gate time is given in equation
Wg=Σ_{n=2,4,6, . . .} ^{∞}[{exp(−RT_{d})}(RT_{d})^{n/2}/((n/2)!)]nwₚ.

Since the results in Experiment (1) presents that Wg=5×10¹⁹ [W/ns], the mean number of photon pairs in the 1-ns open-gate time is around 2.

On the other hand, probability that the photon detector detects the detection signal when the mean number of the input photons is RT_{d} is given in the following equation,
Pₐᵥ=Σ_{m=0,2,4,6, . . .} ²⁸[{exp(−RT_{d})}(RT_{d})^{m/2}/(n!)]×Σₙ₌₁^{m}{ₙCₘ(½^{m})[1−(1−Tη_{1,2})ⁿ]}.

Here, T is the system loss and η_{1, 2} is the quantum efficiency of the photon detectors D₁ and D₂ respectively. If RT_{d}=2 is substituted in this equation, probability that one gate outputs a detection signal becomes 0.076, and the calculated count rate becomes 1.5×10⁴ considering the repetition frequency 200 kHz of the gate, wherein η_{1,2}=0.2 and T=0.2 are assumed. The calculated probability well coincides with the experimental result.

Then, a coincidence-count rate is explained. The coincidence-count rate per one gate is calculated in the following equation,
P_{cc}=[Σ_{m=0,2,4,6, . . .} ^{∞}{exp(−RT_{d})}(RT_{d})^{m/2}/(n!)]×Σₙ₌₁^{m}{ₙCₘ(½^{m})[1−(1−Tη₁)ⁿ][1−(1−Tη₂)^{m-n}]}.

Since this equation includes coincidence counts of photons that have no correlation each other. The coincidence-count probability of the photons that have no correlation each other is to be calculated in the following. This probability is that of occurrence that 2 independent phenomena happen at the same time and is presented in the product of the single counts of the photon detectors D₁ times D₂. Therefore, the probability of coincidence counts of the correlation-free photons is presented in the following equation,
P_{cp}=Σ_{m=0,2,4,6, . . .} ^{∞}{[exp(−RT_{d})](RT_{d})^{m/2}/(n!)}×(Σₙ₌₁^{m}(ₙCₘ)(½^{m})[1−(1−Tη₁)ⁿ])×(Σ_{m=0,2,4,6, . . .} ^{∞}{[exp(−RT_{d})](RT_{d})^{m/2}/(n!)}×Σₙ₌₁^{m}{ₙCₘ(½^{m})[1−(1−Tη₂)ⁿ]}.

Accordingly, the probability for coincidence counts of the photons correlated each other is given in P_{cc}−P_{cp}.

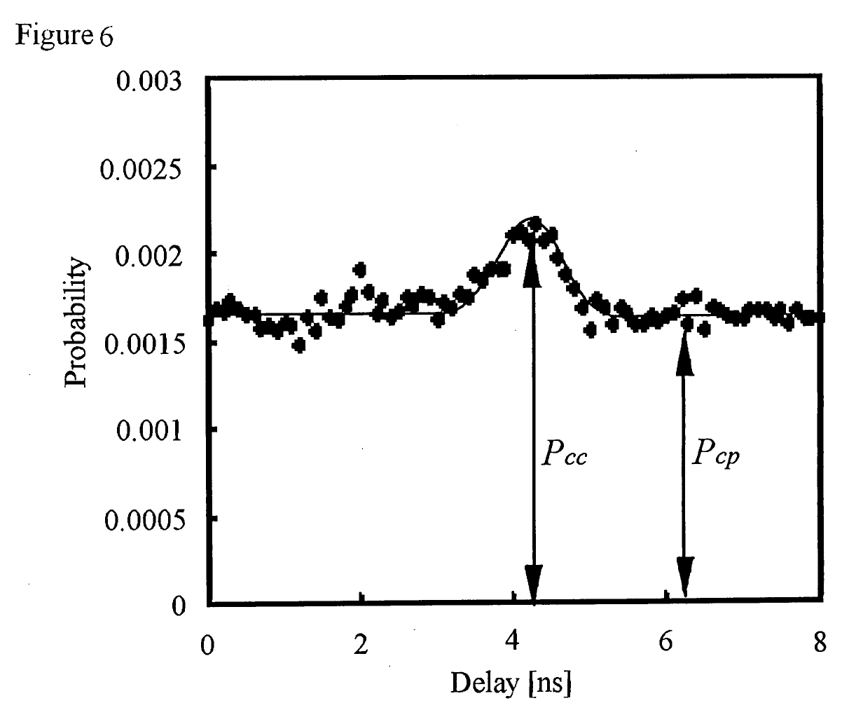

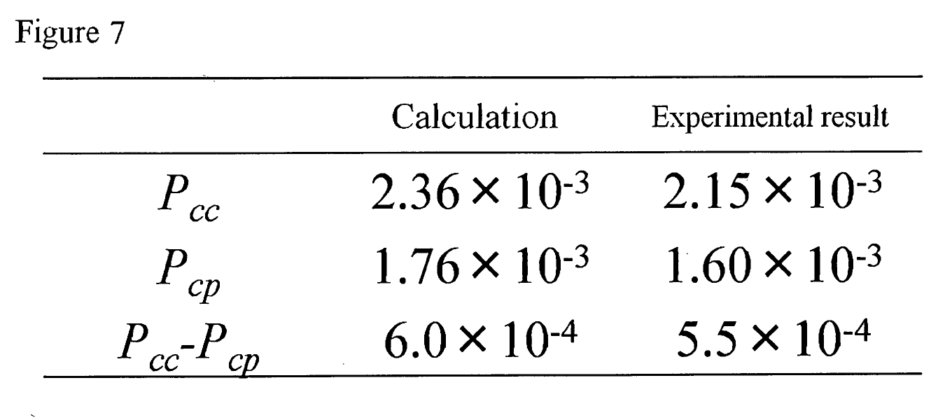

FIG. 6 shows experimental results under the condition that RT_{d}=1.44. When the delay time is 4 ns, the coincidence counts increase, which is because the coincidence counts of the photons correlated to each other appeared. On the contrary, delay times otherwise remain constant coincidence counts, which are caused by photons uncorrelated to each other. The equation of P_{cc} presents the probability of coincidence counts at 4-ns delay time, and the equation of P_{cp} presents that at the rest of the delay time. FIG. 7 together with a table shows the comparison with the calculated by these equations, where provided are η_{1,2}=0.2, R=1.44, T_{d}=1 ns, and T=0.15. The table proves a good agreement of the calculated with the experimented. However, since the gate time on the photon detector is as short as 1 ns, the coincidence counts is very little.

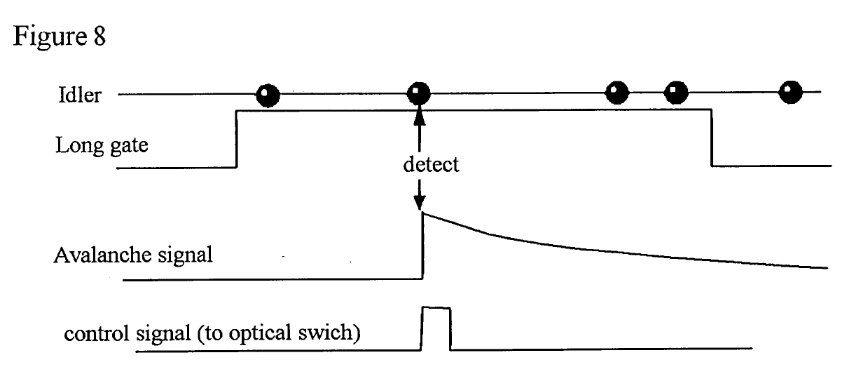

In order to implement a single-photon generator at 1550 nm using photon pairs generated with the PPLN-WG, a single photon detector at 1550-nm band is necessary. This detector usually operates with gating mode, with very short gate time at 1 ns. This causes a low probability for the post selection, and accordingly a very low probability for generating a single photon. In order to solve this difficulty, a means to raise the probability for the post selection must be applied. Then, the gate time of the photon detector for the post-selection side is set longer. As shown in FIG. 8, a longer gate time of the photon detector D₁ increases the mean photon number that comes into the gate, which enables to raise the probability for putting a trigger signal out to open the photon-switch gate. And the photon-switch gate is opened during the short time only when the first trigger signal is put out after there was an input to the gate. The detection circuit used for the single-photon detector at 1550-nm band never puts out detection signals in the same gate again, since a passive quenching function with a time constant set longer than the gate time is provided. This means enables slicing out a single photon in a pulse, according to the gating repetition period of the photon detector D₁, if the detection probability per gate in the photon detector D₁ equals 1. However, strictly saying, the timing to slice a photon out includes uncertainty as long as the gate time employed for the photon detector D₁.

When one of the photon pairs is detected, the detection signal put out of the avalanche photo diode (APD), that is the rising portion of the avalanche signal, has the timing as information that the other photon of the pair exists at. Therefore, very important is a control circuit that reads precisely the rising timing of the avalanche signal and outputs a control signal to open the switch gate at correct timing according to the rising timing. The response time of APD after the photon absorption until the start of avalanche has a jitter from 100 to 200 ps, depending on the voltage applied to the APD. Therefore, assuming that a control signal may be generated without reducing this resolution, an optical switch operable at more than 1 GHz is put into practice.

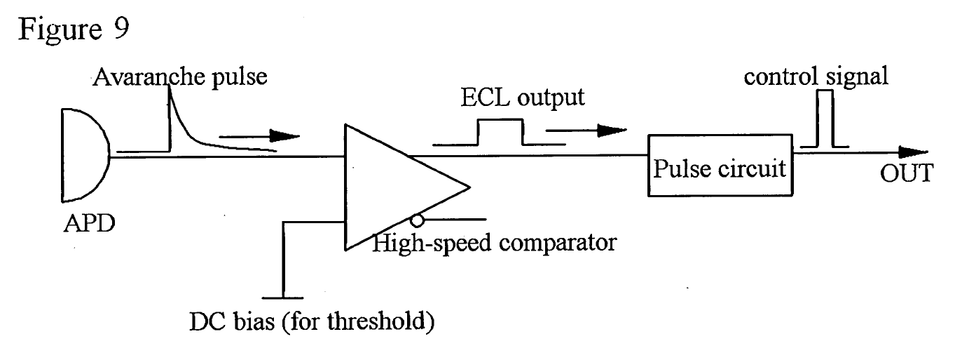

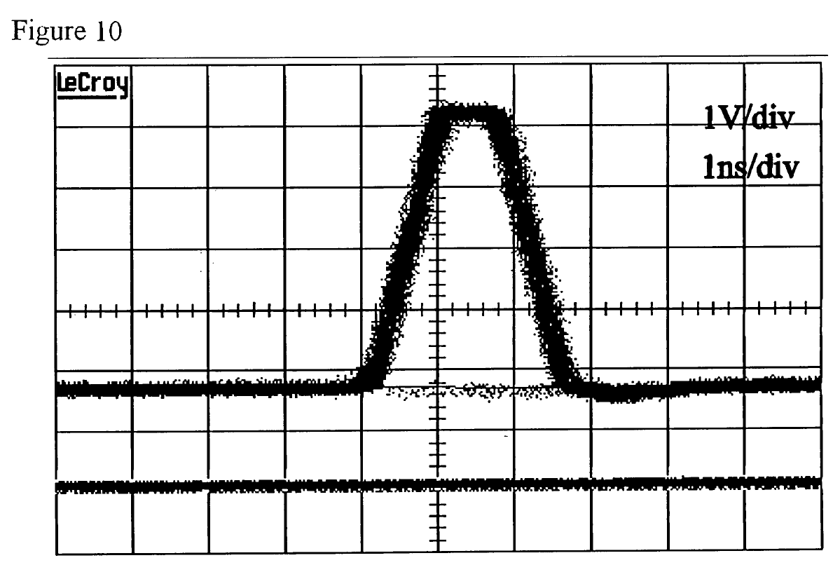

An avalanche signal sensing system depicted in FIG. 9 is implemented using an extreme high-speed comparator (MAXIM MAX9691) with rising time not more than 500 ps and jitter not more than 100 ps. Further implemented is a pulse circuit that converts the output-signal level and reforms the shape to be appropriately used as the control signal of the optical switch or the gate for the photon detector, since the output signal of the comparator is in ECL (Emitter Coupled Logic), that is, L-level equals −1.7 V and H-level equals −0.7 V. Experiments for this circuit are performed using a pulse laser with wavelength 1550 nm and a pulse width 50 ps. The gate width of the single-photon detector was set to be 20 ns and the pulse was put in at 10 ns after the gate was opened. An output signal from the control circuit was measured using an oscilloscope (LeCroy LC574AL) with 1-GHz bandwidth. As shown in FIG. 10, the output signal has a rising time and a falling time of both around 600 ps, and a jitter of around 200 ps. Considering the limited bandwidth of the oscilloscope, the rising may be even steeper. Further considering that the duration time of the H-level is 500 ns, the actual pulse width is regarded as around 1.5 ns. The maximum output voltage of the system is potentially 10 V for 50-Ohm termination impedance. On actual use as control signals, the voltage is adjusted using a programmable attenuator for radio frequency.

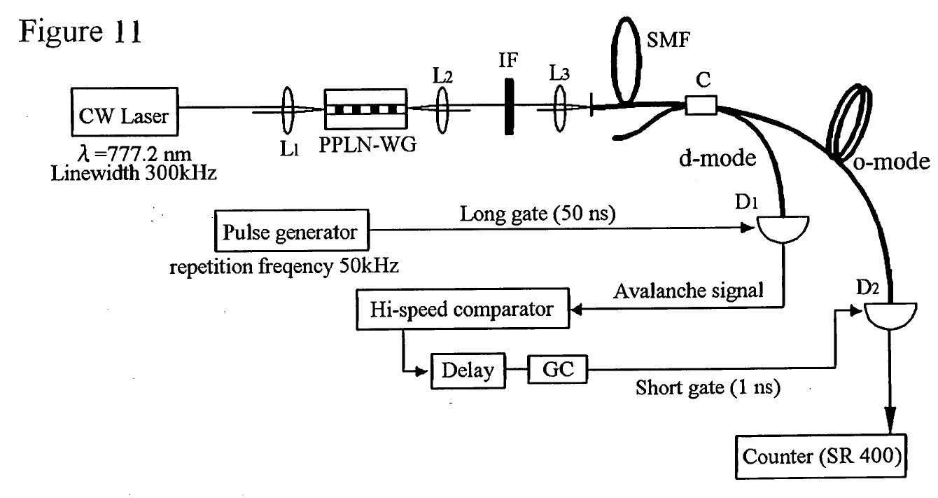

FIG. 11 depicts a schematic diagram of the single-photon generator. Photon pairs of wavelength 1554 nm generated by pumping PPLN-WG using a CW laser of wavelength 777.2 nm are guided into an SMF (single mode fiber). A 50/50 fiber coupler divides the pair to a d(detection)-mode and an o(output)-mode. A photon detector D₁ detects the d-mode photon. The photon detector D₁ is driven with a long-gate mode as long as 50 ns. The repetition frequency of the gate is set as 50 kHz since the long gate time is adopted which causes a high probability of after-pulse generation. The detection signal from the photon detector D₁ is sensed with a threshold of the very high-speed comparator, output from which is delayed and converted to a control signal with pulse width of around 1 ns and voltage of 4.5 V.

On the other hand, the o-mode photon is detected with the photon detector D₂ gated by the control signal. Since the detection result of the photon detector D₂ is on the period alone of the control signal, this detection operation is equivalent to the output-photon detection using both the optical switch and the control signal. The photon detectors D₁ and D₂ use InGaAs/InP-APD (EPITAXX EPM239BA) cooled down to −48° C. with a Peltier device. The quantum efficiency η₁ of the photon detector D₁ is 20% and the dark count probability is 2×10⁻³/50 ns. And the quantum efficiency η₂ of the photon detector D₂ is 20% and the dark count probability is 2×10⁻⁴/1 ns

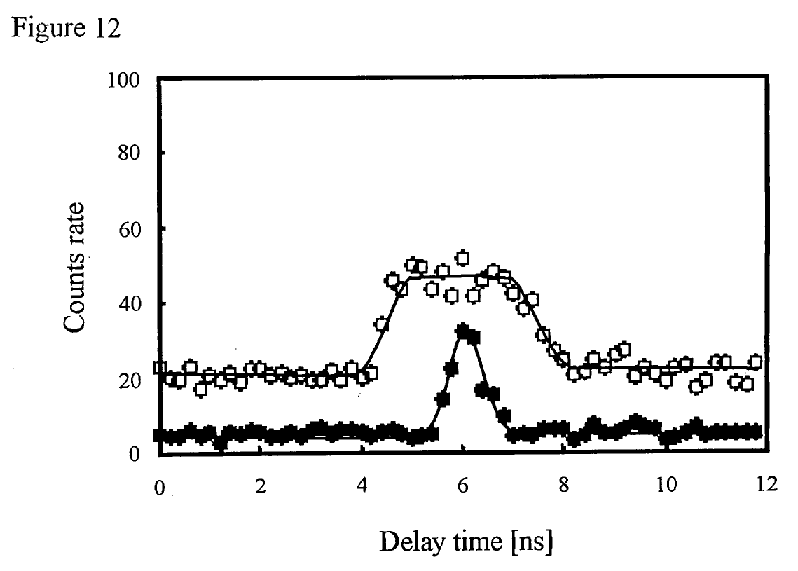

The important point in this experiment setup is whether or not the control signal from the control circuit is applied to D₂ at the right instant when one of the photon pair is put into the photon detector. The count rate of the photon detector D₂ is measured when the control signal is delayed. FIG. 12 shows a comparison of the cases of inputs 1 ns and 5-ns to the photon detector D₂. There is shown a peak at 6-ns delay time, which proves that the control signal is applied at the right time when the correlated photon is put into the photon detector D₂. The whole count rate at 5 ns is more than that at 1 ns, because the mean number of input photons for the 5-ns is larger and the counts of uncorrelated photons increase. Increments of the count rate caused by correlated photons are the same for both the 1-ns and the 5-ns, which proves that the control signal as short as 1 ns is capable of precisely grasping the duration time when the correlated photons exist.

In the photon detector D₁, if all the gates can put detection signals out, the detection signals corresponding to the repetition frequency of the gate is available, although the jitter of 50 ns exists. This availability means that a pulse-light source may be obtained. In order to put this light source into practice, generation probability of the photon pairs must be raised as high as the count rate of the photon detector D₁ is saturated. The pump-light intensity is raised and the generation rate of the photon pairs is increased, where the count rate of the photon detector D₂ against the generation rate of the control signals to the photon detector D₂ i.e. generation rate of the detection signals of the photon detector D₁, is measured.

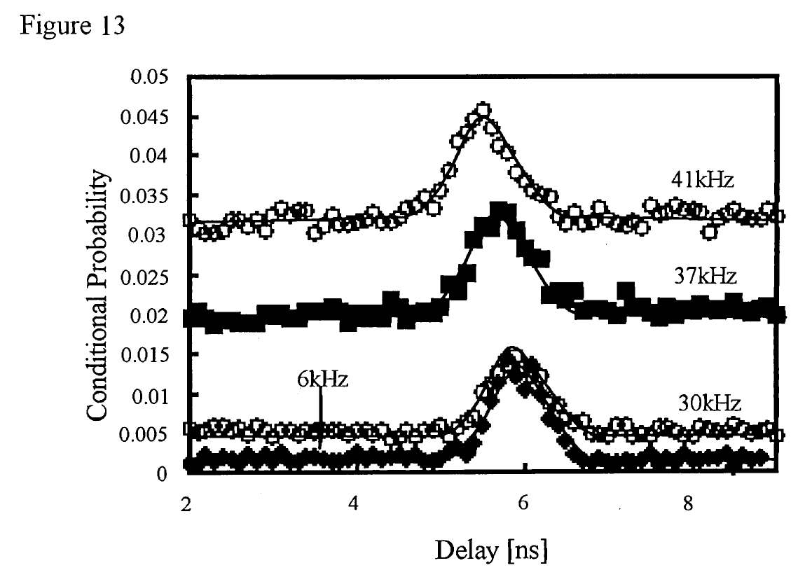

FIG. 13 shows the detection rates of the photon detector D₂ when the generation rates of the control signals are 6, 30, 37, and 41 kHz, where the repetition frequency of the gate of the photon detector D₂ is 50 kHz, and then the count rate of the photon detector D₁ is more than 80% under the condition that the generation rate of the control signal is 41 kHz. In accordance with the increase of the generation rate of the control signals, the count probability of the photon detector D₂ increases. However, a count probability alone of the uncorrelated photons increases and that of the correlated does not. This is because the count probability of the correlated photons does not depend on the generation rate of the control signals but depends on the optical loss of the system, accordingly the increase of the generation rate of the photon pairs results in the increased input probability of the uncorrelated photons into the width of the control signal (i.e. the gate width of the photon detector D₂).

FIG. 13 shows that the mean count probability of the correlated photons is 1.3%. The correlated photons can be put out at probability of around 7% when the control signal is put out, considering the quantum efficiency of the photon detector D₂. While the count of uncorrelated photons may be suppressed down to an almost negligible level at the 6-kHz generation rate of the control signal, the correlated signal can be precisely put out. In other words, a single photon alone can be precisely put out at probability of 7%. On the other hand, the output probability of uncorrelated photons is not negligible if the generation rate of the control signal is more than 30 kHz. However, it is possible to increase the mean photon number with fixed probability of multiple photon output, in other words, only the output probability of the single photon increases.

Here is an example at 37 kHz of generation rate of the control signals. If the quantum efficiency of 20% in the photon detector D₂ is compensated for, the mean output number of the whole photons becomes 0.16 under effects of the correlated photons. On the other hand, that of uncorrelated photons is 0.1. Distribution of the photons is approximated with the Poissonian here, since the loss is large at this case although the distribution spreads wider than Poisson distribution at the parametric down-conversion. This assumption leads to a probability of multiple-photon output of the mean photon number around 0.1 in Poissonian distribution. This result corresponds to an improvement of multiple-photon output probability by 4 dB.

This example employs a degenerate spontaneous parametric down-conversion with the same signal-photon wavelength as the idler-photon wavelength, and then utilizes a fiber coupler to separate the signal photon from the idler photon. Therefore, both the signal photon and the idler photon are guided to the same port with a probability of ½. As a result, as far as this phenomenon, correlated photons are not always precisely put out. In order to solve this problem, utilizing a non-degenerate parametric down-conversion with wavelengths of 1550 nm and 1560 nm for example, enables efficient separation of the signal photon against the idler photon and doubles the output probability of the correlated photons. Furthermore, a junction with the fiber loses as large as 7 dB and then the optimization for the loss further improves the output probability of the correlated photons. These improvements above mentioned enable saturation of the count rate of the photon detector D₁ at low photon-generation rate and make pulse-like photon generation easier.

As described above, the embodiment in the present invention is configured with the single-photon generator comprising the spontaneous parametric down-conversion that generates two photons, and then optical switch utilizing the LN polarization modulator that makes the single photon selectively pass through, can efficiently generate a single photon.

### APPLICABILITY TO INDUSTRY

The single photon generator by the present invention is the most appropriate for the optical communication system with quantum cryptography. Furthermore, it is well applicable as a single-photon generating device for interaction-free measurement.

1. A single-photon generation device comprising a laser-light source, a wave-guide-type quasi-phase-matching LiNbO₃ that converts one photon from said laser-light source into two photons with a common wavelength, a beam splitter that separates the two photons, a single-photon detector that detects one of the separated photons, and an optical switch that puts the other of the separated photons in and is controlled with the detection signal of said single-photon detector.

2. A single-photon generation device comprising a laser-light source, a non-degenerate wave-guide-type quasi-phase-matching LiNbO₃ that converts one photon from said laser-light source into two photons with different wavelengths, a dichroic mirror that separates the two photons with the different wavelengths, a single-photon detector that detects one of the separated photons, and an optical switch that puts the other of the separated photons in and is controlled with the detection signal of said single-photon detector.

3. A single-photon generation device comprising a laser-light source, a bulk-type quasi-phase-matching LiNbO₃ that converts one photon from said laser-light source into two photons and put them out to different directions, a single-photon detector that detects one of the separated photons, and an optical switch that puts the other of the separated photons in and is controlled with the detection signal of said single-photon detector.
